(19) United States
(12) Patent Application Publication
(10) Pub. No.: US 2016/0079761 A1
(43) Pub. Date: Mar. 17, 2016

(54) SYSTEM AND METHOD FOR POWER POINT TRACKING FOR PHOTOVOLTAIC CELLS

(71) Applicant: THE BOARD OF TRUSTEES OF THE UNIVERSITY OF ILLINOIS, Urbana, IL (US)

(72) Inventors: Robert Pilawa-Podgurski, URBANA, IL (US); Alejandro Dominguez-Garcia, URBANA, IL (US); Shibin Qin, URBANA, IL (US); Stanton Cady, URBANA, IL (US)

(21) Appl. No.: 14/851,625

(22) Filed: Sep. 11, 2015

Related U.S. Application Data
(60) Provisional application No. 62/050,518, filed on Sep. 15, 2014.

(51) Int. Cl. H02J 3/38; H02S 40/34; G01R 31/40

(52) U.S. Cl. CPC H02J 3/385; H02S 50/00; H02S 40/34

(57) ABSTRACT

A system includes a first photovoltaic sub-module connected with a second photovoltaic sub-module. A first differential power processing converter connects with the first photovoltaic submodule and the second photovoltaic sub-module, and a third photovoltaic sub-module connects with the second photovoltaic sub-module and the first differential power processing converter. A second differential power processing converter connects with the first differential power processing converter, the first photovoltaic sub-module, the second photovoltaic sub-module and the third photovoltaic sub-module, where the second differential power processing converter communicates with the first differential power processing converter to exchange an information about determined perturbation of the first differential power processing converter and the second differential power processing converter.

### CROSS-REFERENCE TO RELATED APPLICATION

This application claims the benefit of U.S. Provisional Application Ser. No. 62/050,518, filed Sep. 15, 2014, which is incorporated in its entirety herein.

### GOVERNMENT LICENSE RIGHTS

This invention was made with government support under grant number DE-AR0000217 awarded by the Advanced Research Projects Agency-Energy (ARPA-E). The government has certain rights in the invention.

### BACKGROUND

Photovoltaic (PV) cells are used to generate electrical power by converting solar radiation into direct current electricity using semiconductors that exhibit the photovoltaic effect. Photovoltaic power generation can employ solar panels composed of a number of solar cells containing a photovoltaic material. Solar photovoltaics power generation has been seen as a clean sustainable energy technology which draws upon the planet's most plentiful and widely distributed renewable energy source, the sun. The direct conversion of sunlight to electricity can occur without any moving parts or environmental emissions during operation.

### BRIEF DESCRIPTION OF THE DRAWINGS

In association with the following detailed description, reference is made to the accompanying drawings, where like numerals in different figures can refer to the same element.

FIGS. 1A-C are circuit diagrams of exemplary distributed power electronics solutions for photovoltaic systems.

FIG. 2 is a graph of an example maximum power of PV sub-modules and differential power of a 30 PV sub-module system with randomly generated irradiance condition.

FIG. 3 is a block diagram of an example 3-sub-module, 2-DPP system.

FIG. 4 is a timeline for an example slow control loop, e.g., central inverter, and fast control loop, e.g., DPP.

FIG. 5 is a timeline of an example perturb an observe for the 3-sub-module, 2-DPP system.

FIG. 6 is a flowchart of an example algorithm for the 3-sub-module, 2-DPP system.

FIG. 7 is a graph of an example n-sub-module, (n−1)-DPP system.

FIG. 8 is a block diagram of components for an example simulation platform.

FIG. 9A and FIG. 9B are graphs of an example evolution of duty ratios determined by the distributed algorithm for the system, with fixed γ for a 6-sub-module, 5-DPP system.

FIG. 10 is a graph of an example evolution of duty ratios determined by the distributed algorithm for the system, with adaptive γ for a 6-sub-module, 5-DPP system.

FIG. 11 is a graph of an example 6-module, 5-DPP system with redundant communications.

FIG. 12 is a graph of an example evolution of duty ratios computed by distributed algorithm with communication failure reconfiguration.

FIG. 13 is a graph of an example 6-submodule, 5-DPP system with communication failure.

FIG. 14 is a graph of an example evolution of duty ratios determined by the distributed algorithm with communication failure reconfiguration.

FIG. 15 is a circuit diagram of an example PV junction box connection for DPP system.

FIG. 16 is a schematic of an example hardware design shown for DPP₂.

FIG. 17 is a graph of an example measure efficiency of the 3 DPPs on one hardware prototype at 10 V input voltage, 50% duty ratio.

FIG. 18 is a block diagram of an example setup.

FIG. 19 is a graph of an example I-V characteristics of 3 sub-modules with 100%, 80% and 50% normalized irradiance.

FIG. 20 is a graph of an example string P-I characteristics of a 2-DPP system with irradiance pattern of 100%, 80% and 50%.

FIGS. 21A-C are graphs of example evolution of duty ratios computed by the distributed algorithm for a 2-DPP system.

FIGS. 22A-C are an example evolution of duty ratios computed by distributed algorithm for a 5-DPP system with irradiance pattern of 100%, 100%, 80%, 80%, 50%, 50%, I_{string}=3.3 A, δ=0.1 and different γ.

FIG. 23 is a graph of evolution of duty ratios computed by the distributed algorithm for 31-DPP simulation with 100% irradiance on all sub-modules and random initial duty ratios.

### DETAILED DESCRIPTION

Distributed systems, methods and algorithm control differential power processing converters in photovoltaic (PV) applications. In one example, the systems, methods and algorithm may achieve true maximum power point tracking (MPPT) of series-connected PV sub-modules by relying only on local voltage measurements and neighbor-to-neighbor communication between the differential power converters. Compared to previous solutions, the systems, methods and algorithm may achieve reduced number of perturbations at each step and faster tracking without adding extra hardware. The systems, methods and algorithm can be suited for long sub-module strings.

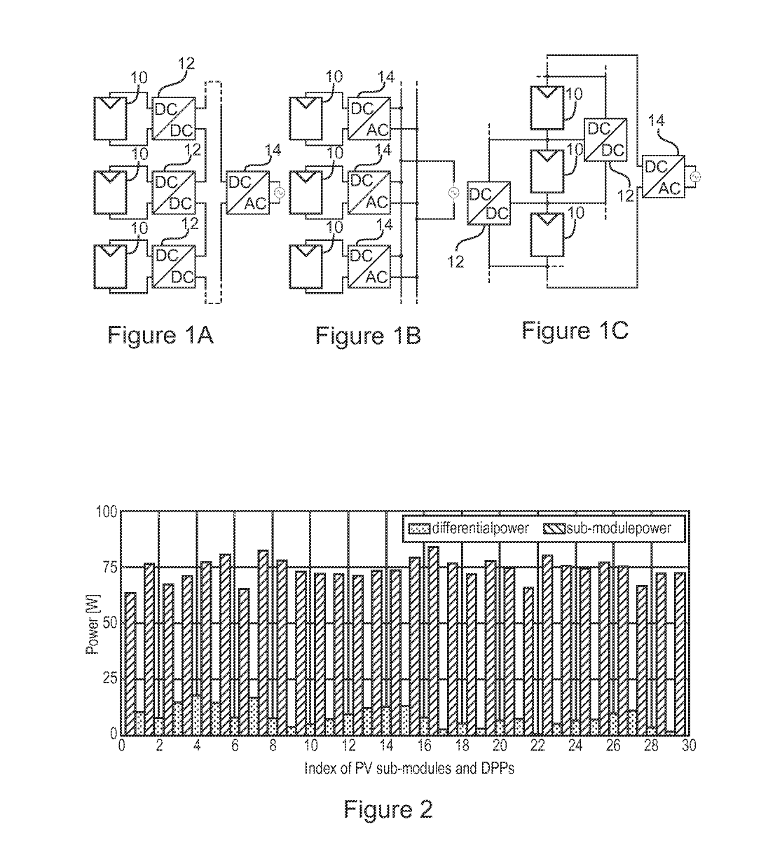

FIGS. 1A-C are circuit diagrams of exemplary distributed power electronics solutions for photovoltaic systems. FIG. 1A is an example DC optimizer, FIG. 1B is an example micro-inverter, and FIG. 1C is an example differential power processing (DPP)-based system. In photovoltaic (PV) energy systems, PV modules 10 are often connected in series for increased string voltage, e.g. via direct current (DC) to DC 12 and/or DC to alternating current (AC) 14 buck converters. However, there may be mismatch between the I-V characteristics of the series connected PV modules 10; this is typically the result of partial shading, manufacturing variability and thermal gradients. Since all modules in a series string share the same current, the string output power may be limited by underperforming modules. A bypass diode can be connected in parallel with each PV module to mitigate this mismatch and prevent PV hot spotting, but the efficiency loss is still significant when only a central converter is used to perform MPPT on the PV string.

To address the mismatch problem, distributed power electronics architectures that perform module-level MPPT, or even sub-module-level MPPT, have been used. Two dominant architectures include DC optimizers, and micro-inverters, e.g., shown in FIG. 1A and FIG. 1B respectively. The distributed converters are connected in series with the PV modules 10 and process the full power output of every module. Even with highly efficient distributed converters, the overall power losses of the system can still be significant.

Differential power processing (DPP) for PV applications has gained significant attention recently due to its improvements over conventional solutions in terms of efficiency, reliability, and cost. An example structure of a DPP-based system in shown in FIG. 1C. In contrast to DC optimizers or micro-inverters, DPP converters, or differential power processors (DPPs), are configured in parallel with the PV string. The bulk power that is common to all PV modules 10 is directly processed by the central inverter without any intermediate conversion. DPP converters only need to process the power difference between series connected PV modules 10, which is often just a small fraction of the bulk power. This results in high efficiency of the system, small size and low power ratings of the power electronics circuit components. Due to these advantages, DPP has been further extended to apply to sub-module-level applications.

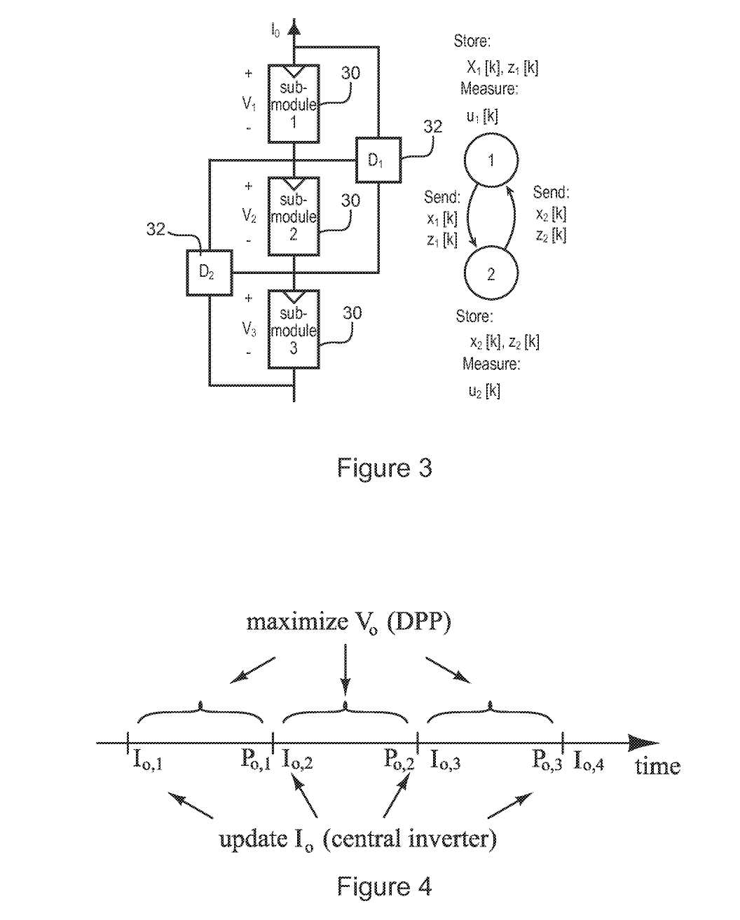

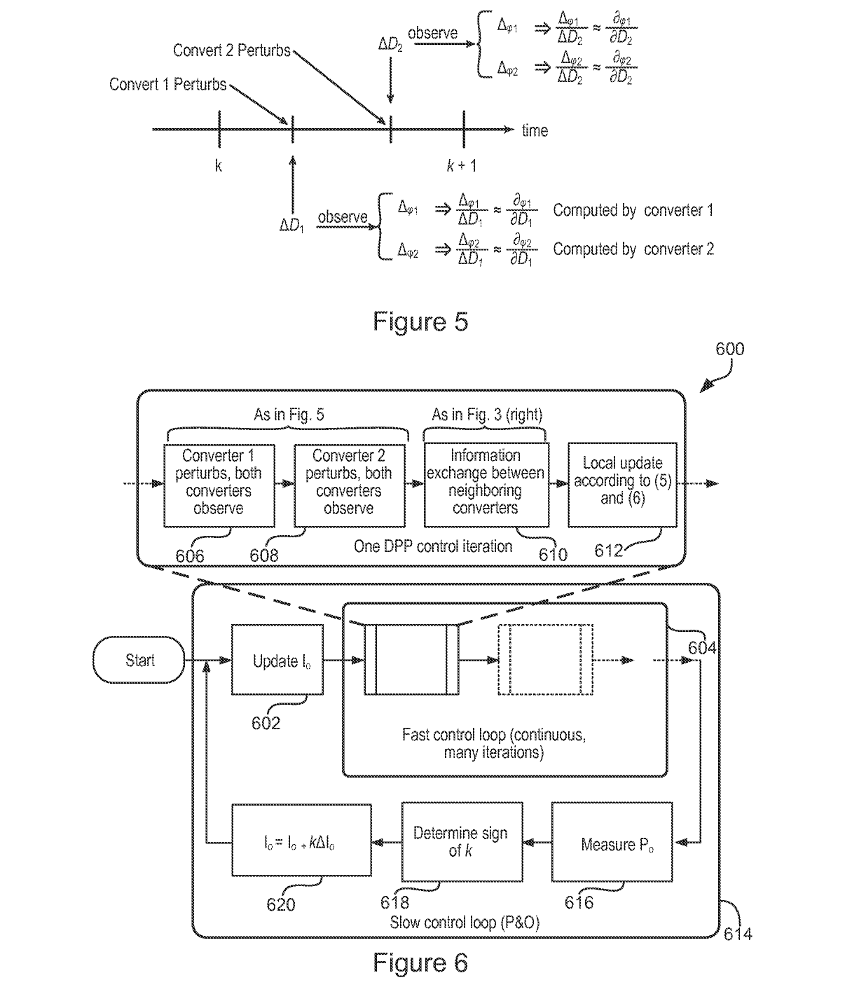

FIG. 2 is a graph of an example maximum power of PV sub-modules 30 and differential power processing (DPP) converters 32 of a thirty PV sub-module 30 system with randomly generated irradiance condition (See also FIG. 3 for a three sub-module 30, 2-DPP 32 system). Other number of sub-modules can be used, e.g., more or less than thirty, e.g., ninety. To compare the efficiency of a DPP-based system with micro-inverters or DC optimizers, consider a system with ten PV modules 10 (e.g., thirty PV sub-modules 30) as an example. The irradiances on the PV sub-modules 30 are set randomly by drawing from a Gaussian distribution with a standard deviation equal to 10% of the mean. The resulting maximum power of each PV sub-module is displayed in FIG. 2 using striped bars. The differential power, e.g., the power difference between the maximum power of each PV module and the power common to all PV modules 10, is also shown in FIG. 2 using dotted bars. In a DC optimizer-based system, the DC optimizers process the full power of all PV sub-modules 30 (represented by the striped bars), which adds up to 2218 W. In a DPP-based system, each DPP 32 only needs to process the differential power (represented by the dotted bars), which only adds up to 242.5 W. Both the DC optimizer-based system and the DPP-based system then use a string-level inverter to convert DC string voltage into AC voltage.

In a micro-inverter system, the PV module voltage is directly converted to AC, but the efficiency of a micro-inverter is typically lower and its per-watt cost is typically higher than that of a string-level inverter or a central inverter. Table 1 summarizes example power losses of these three different solutions for the irradiance condition in this example. DC optimizers are assumed to have an average efficiency of about 95%, while that of DPP converters 32 is assumed to be 92% since they often operate in light-load conditions. For both the DC optimizer and DPP-based system, a string inverter efficiency of 98% was assumed. The micro-inverters are assumed to have an efficiency of 95%, and since, in practice, they only interface with PV modules 10, and therefore cannot compensate mismatch between sub-modules 30, the effective efficiency is typically even lower. In Table 1, the DPP-based system yields advantages in terms of overall system efficiency.

Comparison of system efficiency of the DC optimizer-based system, the micro-inverters and the DPP-based system

| Losses/Solutions | DC optimizer | Micro-inverter | DPP |
|---|---|---|---|
| Power processed by | 2218 | N/A | 242.5 |
| DC stage [W] | | | |
| Intermediate power | 2218 × 4% = | N/A | 242.5 × 8% = |
| losses [W] | 88.7 | | 19.4 |
| Power processed by | 2218 − 88.7 = | 2218 | 2218 − 19.4 = |
| inverter(s) [W] | 2129.3 | | 2198.6 |
| Inverter power losses | 2129.3 × 2% = | 2218 × 5.0% = | 2198.6 × 2% = |
| [W] | 42.6 | 110.9 | 44.0 |
| Overall efficiency | 94.08% | 95.00% | 97.14% |

To apply the concept of differential power processing to PV systems, especially at the sub-module-level, several architectures and corresponding control schemes have been proposed. For example, a switched inductor topology; a resonant switched capacitor topology; and a transformer coupled topology. The solutions adopt a control method commonly known as voltage equalization or “virtual parallel” operation, in which all distributed converters strive to equalize the voltages of all PV sub-modules 30 in a string. The distributed converters in the system run in open loop, simplifying the control requirements while obviating the need for communication among converters. However, the voltage equalization approach can only achieve near maximum power point (MPP) operation without truly seeking the MPP of each individual sub-module. The effectiveness of these approaches rely on the fact that the MPP voltages of sub-modules 30 in a string are very close even if their MPP currents differ significantly. This can require all the sub-modules 30 to have very similar electrical characteristics, which in practice is typically guaranteed by a costly binning process performed by PV module manufacturers. However, even modules that are carefully matched at installation will suffer from non-uniform degradation after several years of field exposure. The standard deviation of PV module MPP voltages may increase by nearly four times over a twenty-year period. Furthermore, field operating conditions that result in thermal gradients or severe irradiance mismatch along the PV string can also cause the MPP voltages of sub-modules 30 to drift apart. All of these factors limit the tracking efficiency of the voltage equalization approach.

The generation control circuit presented may achieve true MPPT without any local current sensing at each sub-module, but employs a control scheme that requires communication between all converters and a central control unit. The central control unit has to (i) command all the DPP converters 32 to exhaust every combination of converter duty ratio, e.g., cycle, perturbations, and (ii) measure the string voltage respectively in sequence before making the next DPP tracking step. For a system with n DPP converters 32, the central control unit has to try 2ⁿ duty ratio perturbations during each DPP tracking step, rendering the algorithm slow and infeasible for a large system. Moreover, with this approach, the reliability of the system is limited, as a single failure of the central control unit, or a communication link failure, can result in the malfunction or complete loss of the overall system. A buck-boost converter topology can be adapted that overcomes at least some of the limitations in the architecture of the generation control circuit, and achieves true MPPT with a faster control scheme. However, this control scheme still requires communication between all DPP converters 32 and the central converter. The approach may require measurements of all PV sub-module currents, which results in additional power losses. Moreover, this approach requires synchronization between power converters, which still relies on some communication.

Implementing local current measurement impairs the system efficiency and increases the hardware cost, whereas implementing communication may result in a much smaller impact because communication hardware is often required for other purposes, including individual PV module diagnostics and on/off capability. Distributed systems, methods and algorithm eliminate local current sensing while preserving communication, but to reduce the communication requirement to overcome the limitations of the centralized approaches. The systems, methods and algorithm can use only neighbor-to-neighbor communication between adjacent DPP converters 32 to perform sub-module-level true MPPT. There is no need for a central control unit or any local current sensing. Each DPP only perturbs its duty ratio once per DPP tracking step, so for a system with n DPP converters 32, only n duty ratio perturbations are required per DPP tracking step (instead of 2ⁿ perturbations in other systems). Each DPP converter observes only local voltage changes, e.g., instead of the entire string voltage. Moreover, the systems, methods and algorithm may provide parallelization of the duty ratio perturbations as the sensitivity between non-adjacent DPP converters 32 is low, which can reduce the communication overhead and speed up the tracking even further. Compared to the centralized counterparts, no extra hardware is needed since the algorithm can be implemented in the DPP converter micro-controllers that already exist for converter local control. Furthermore, since a central control unit is unnecessary and each micro-controller can make independent control decisions, there is no longer a single point of failure, increasing the overall system reliability.

FIG. 3 is a block diagram of an example 3-sub-module, 2-DPP system. The DPP converters 32 are connected at three points to two neighboring sub-modules 30, and to a neighboring DPP, e.g., to exchange power and/or other information between the sub-modules 30 and the DPPs 32. In other implementations the differential power processing to PV systems can be applied at the module level. The system can utilize a distributed iterative algorithm which, through the exchange of information among local controllers, and for a given string current, maximizes the power extracted from an array of n series-connected PV sub-modules 30 outfitted with n−1 DPP converters 32. In FIG. 3, the information that two local controllers exchange are the current values of the duty cycles of their corresponding DPPs, as well as estimates that each DPP controller computes of the duty cycle of the other DPP. The information that each controller exchanges with its neighbor is its actual duty ratio and its estimate of its neighbor's duty ratio. In addition to the duty ratios (for MPPT control), the converters can exchange information regarding their current, voltage, temperature, and health indicators, which would be useful from an operation perspective. The given string current can remain constant for the PV system. The algorithm is formulated for a 3-sub-module, 2-DPP system, and then generalized to a system of any size. Each DPP converter 32 can be implemented as a bidirectional buck-boost converter that enforces a voltage ratio between two adjacent PV sub-modules 30. The PV string is attached to a central converter (not shown in FIG. 3). A control objective of the MPPT algorithm is to maximize the power extracted from the PV string, Pₒ, e.g.,

$${maximize}_{{D}_{1} {D}_{2}} {P}_{o} = {V}_{o} \times {I}_{o} , \qquad ( 1 )$$

where Iₒ is the string current, and Vₒ:=V₁+V₂+V₃ is the string voltage. Given an irradiance condition, each PV sub-module has a unique maximum power point (V_{i,max}, I_{i,max}) i=1, 2, 3. When each PV sub-module is operating at its respective maximum power point, the entire system is operating at its global maximum power point, and the corresponding string current and the string voltage can be uniquely determined through Kirchhoff's current law (KCL) and Kirchhoff's voltage law (KVL) analysis as V_{o,max} and I_{o,max}. Moreover, the duty ratios of all DPP converters 32, D_{1,max} and D_{2,max}, can be uniquely determined, such that I_{o,max}, D_{1,max} and D_{2,max} form a set of variables that fully determines the system. The control objective thus entails tracking the unique combination of (I_{o,max}, D_{1,max}, D_{2,max}) that corresponds to P_{o,max}.

FIG. 4 is a time line for an example slow control loop, e.g., central inverter, and fast control loop, e.g., DPP. The setting of Iₒ and Vₒ can be separated into the two control loops. In the relatively slow control loop, the central converter is configured as a controllable current sink, and it can perform a conventional perturb and observe (P&O) algorithm to seek the string current Iₒ that gives the largest Pₒ. In the second, relatively fast control loop compared to the slow control loop, all DPP converters 32 adjust their duty ratios in each DPP tracking iteration and take many iterations to maximize Vₒ. Since the perturbation interval of the central converter is much longer than the time constant of the DPP converter control loop, e.g., because the DPP converters 32 are switching at a much higher frequency discussed below, at any given time, the string current Iₒ can be considered temporarily fixed for the DPPs. Given a fixed string current Iₒ, regardless of the irradiance incident on each of the sub-modules 30, maximizing the string voltage Vₒ is equivalent to maximizing Pₒ.

FIG. 4 illustrates the operation of the two control loops: in the slow control loop, the central inverter employs a P&O algorithm, such that it first updates and enforces (“perturb”) a certain string current value, Iₒ. Following this, the DPP converters 32 may take many iterations in the fast control loop to maximize the string voltage Vₒ for this Iₒ. The string power is then measured (“observed”) by the central inverter to use in its P&O algorithm. The slow and fast control loops can repeat this pattern and find the optimal string current I_{o,max}.

Here, it can be assumed that the slow loop implemented in the central inverter uses a conventional P&O algorithm to seek I_{o,max}, and utilizes a distributed control algorithm for DPPs in the fast control loop. The distributed optimization algorithm in B. Gharesifard and J. Cortes, “Distributed continuous-time convex optimization on weight-balanced digraphs,” IEEE Transactions on Automatic Control, VOL. 59, NO. 3, pp. 781-786, March 2014 can be modified to develop the algorithm for DPPs, the mathematics of which are described below.

$$\begin{matrix}∇ V ( {D}_{1}^{*} , {D}_{2}^{*} ) = [ \begin{matrix}\frac{\partial {V}_{1} ( {D}_{1} , {D}_{2} )}{\partial {D}_{1}} {{\vert}_{{D}_{1}^{*} , {D}_{2}^{*}} + \frac{\partial {V}_{2} ( {D}_{1} , {D}_{2} )}{\partial {D}_{1}} \vert}_{{D}_{1}^{*} , {D}_{2}^{*}} + \frac{\partial {V}_{1} ( {D}_{1} , {D}_{2} )}{\partial {D}_{1}} {{\vert}_{{D}_{1}^{*} , {D}_{2}^{*}} + \frac{\partial {V}_{2} ( {D}_{1} , {D}_{2} )}{\partial {D}_{1}} \vert}_{{D}_{1}^{*} , {D}_{2}^{*}} \\ \frac{\partial {V}_{1} ( {D}_{1} , {D}_{2} )}{\partial {D}_{1}} {{\vert}_{{D}_{1}^{*} , {D}_{2}^{*}} + \frac{\partial {V}_{2} ( {D}_{1} , {D}_{2} )}{\partial {D}_{1}} \vert}_{{D}_{1}^{*} , {D}_{2}^{*}} + \frac{\partial {V}_{1} ( {D}_{1} , {D}_{2} )}{\partial {D}_{1}} {{\vert}_{{D}_{1}^{*} , {D}_{2}^{*}} + \frac{\partial {V}_{2} ( {D}_{1} , {D}_{2} )}{\partial {D}_{1}} \vert}_{{D}_{1}^{*} , {D}_{2}^{*}}\end{matrix} ] = [ \begin{matrix}0 \\ 0\end{matrix} ] & ( 2 ) \\ u [ k ] := {{[}_{{u}_{1} [ k ] = \frac{\underbrace{\partial } {ϕ}_{1} ( D )}{\partial D}} \frac{\partial {ϕ}_{1}}{\partial {D}_{1}} {{\vert}_{{D}_{1} [ k ] , {D}_{2} [ k ]} , \frac{\partial {ϕ}_{1}}{\partial {D}_{2}} \vert}_{{D}_{1} [ k ] , {D}_{2} [ k ]} {,}_{{u}_{2} [ k ] = \frac{\underbrace{\partial } {ϕ}_{2} ( D )}{\partial D}} \frac{\partial {ϕ}_{2}}{\partial {D}_{1}} {{\vert}_{{D}_{1} [ k ] , {D}_{2} [ k ]} , \frac{\partial {ϕ}_{2}}{\partial {D}_{2}} \vert}_{{D}_{1} [ k ] , {D}_{2} [ k ]} ]}^{T} , & ( 7 )\end{matrix}$$

Each DPP may have access to measurements of only two of the three sub-module voltages instead of the entire string. Thus, in order to determine the duty ratios for which Vₒ is maximized, the local controllers of DPP₁ and DPP₂ can share information through neighbor-to-neighbor communication. The information can be shared via wire and/or wirelessly, e.g., using WiFi, ZigBee, or other protocols, etc. This can be described by a directed graph, as shown on the right of the block diagram in FIG. 3. The distributed optimization algorithm can be tailored to this setting.

The control objective described above can be written as:

$${maximize}_{{D}_{1} , {D}_{2}} {V}_{o} ( {D}_{1} , {D}_{2} ) = {V}_{1} ( {D}_{1} , {D}_{2} ) + {V}_{2} ( {D}_{1} , {D}_{2} ) + {V}_{3} ( {D}_{1} , {D}_{2} ) ,$$

where D₁ and D₂ are the duty ratios of DPP₁ and DPP₂, respectively. Then, the maxima of the function Vₒ(D₁, D₂) can be found by setting its gradient to zero, as in (2), where D₁^{*} and D₂^{*} are the respective duty ratios of DPP₁ and DPP₂ that correspond to the maximum power point. To find D₁^{*} and D₂^{*}, the local controller of each DPP iteratively adjusts its duty ratio based on (i) local voltage measurements, (ii) state variables maintained locally, and (iii) variables maintained by neighboring DPPs. Let k=1, 2, . . . index the iterations performed by every DPP, and let x₁[k], x₂[k] be state vectors maintained by the local controllers of DPP₁ and DPP₂, respectively. For DPP₁, the entries of x₁[k] are D₁[k]—the actual duty ratio of DPP₁, and \hat{D}_{1,2}[k] —DPP₁'s estimate of the duty ratio of DPP₂. Similarly, for DPP₂, the entries of x₂[k] are \hat{D}_{2,1}[k]—DPP₂'s estimate of the duty ratio of DPP₁, and D₂[k]—the actual duty ratio of DPP₂. Furthermore, let z₁[k] and z₂[k] be ancillary state vectors maintained by the local controllers respectively; unlike x₁[k] and x₂[k], these ancillary states do not correspond to any physical variable. For the system, determine:

$$\begin{matrix}x [ k ] = {[ {⏟}_{{x}_{1} [ k ]} {D}_{1} [ k ] , {\hat{D}}_{1 , 2} [ k ] , {⏟}_{{x}_{2} [ k ]} {\hat{D}}_{2 , 1} [ k ] , {D}_{2} [ k ] ]}^{T} , & ( 3 ) \\ z [ k ] = {[ {⏟}_{{z}_{1} [ k ]} {z}_{1 , 1} [ k ] , {z}_{1 , 2} [ k ] , {⏟}_{{z}_{2} [ k ]} {z}_{2 , 1} [ k ] , {z}_{2 , 2} [ k ] ]}^{T} . & ( 4 )\end{matrix}$$

Then, at each iteration, the variables are updated as:

x[k+1]=(I₄−δ\tilde{L})x[k]−δ\tilde{L}z[k]+δγu[k], (5)

z[k+1]=z[k]+δ\tilde{L}x[k], (6)

where I₄ is the 4×4 identity matrix; L=L [symbol] I₂, where I₂ is the 2×2 identity matrix,

$$L = [ \begin{matrix}1 & - 1 \\ - 1 & 0\end{matrix} ]$$

is the Laplacian matrix of the graph representing the exchange of information between local controllers as depicted in FIG. 3, and “ [symbol] ” denotes the Kronecker product of L and I₂; δ and γ are parameters that can be used to tune the algorithm, discussed below; and u[k] is determined as in (7) at the bottom of this page, with φ₁ and φ₂ determined respectively as:

φ₁(D₁,D₂):=V₁(D₁,D₂)+½V₂(D₁,D₂),

φ₂(D₁,D₂):=½V₂(D₁,D₂)+V₃(D₁,D₂).

FIG. 5 is a timeline of an example perturb an observe for the 3-sub-module, 2-DPP system. From the above, the update of DPP₁'s states, x₁[k+1] and z₁[k+1], depends on its own states, x₁[k] and z₁[k], the states of its neighbor, x₂[k] and z₂[k], and the partial derivatives of the sub-module voltages that DPP₁ is directly attached to, e.g., u₁[k]. In this regard, while the necessary information that each DPP converter uses for updating (5) and (6) can be acquired through neighbor-to-neighbor communication, in order to obtain uᵢ[k], each DPPⁱ estimates the partial derivatives of the φᵢ(•) function. To perform this estimation, at every iteration, each DPPⁱ alternatively perturbs its duty ratio by a fixed small amount, ΔDᵢ, while both local controllers observe the sub-module voltages; the timeline of this process is depicted in FIG. 5. After both local controllers have observed the results of each perturbation, and upon receiving the necessary information from the neighboring DPP, they can approximate the partial derivatives as

$$\frac{\partial {ϕ}_{i}}{\partial {D}_{j}} \approx \frac{{Δϕ}_{i}}{Δ {D}_{j}} , i , j = 1 , 2 ,$$

and update their respective state variables. After k=m iterations, for m sufficiently large, D₁ [m]≈D₁^{*} and D₂[m]D₂^{*}; thus the string voltage is maximized and the maximum power is extracted from the system at a given string current Iₒ. The fast control loop continuously tracks the maximum power and once the slow control loop updates Iₒ to a new value, the fast control loop will maximize the output power for this new condition.

FIG. 6 is a flowchart 600 of an example algorithm for the 3-sub-module, 2-DPP system. The flowchart in FIG. 6 describes an example of how the two control loops operate and interact. Note that the two control loops need not be time synchronized, but can operate independently of one another. The given string current Iₒ can be updated during iterations (602). During the fast control loop (604), converter 1 perturbs and both converter 1 and converter 2 observe the perturbation (see also FIG. 5) (606). Then, converter 2 perturbs and both converter 1 and converter 2 observe the perturbation (see also FIG. 5) (608). The perturbation interval is synchronized between neighboring converters, e.g., converter 1, converter 2, etc. (FIG. 3) (610). A local update occurs to according to (5) and (6); e.g., the controller associated to each DPP updates its duty cycle to be a weighted linear combination of (i) the previous duty cycle value, (ii) the previous values of the duty cycle estimates of the neighboring DPSS, and (iii) the partial derivative (as determined via the perturb and observe method described earlier) of its portion of the cost function (612). The update information is passed from the fast control loop to the slow control loop 614 to measure Pₒ (616). The algorithm determines the sign of k from the measured power Pₒ (618) and the k is used to update the string current Iₒ as Iₒ=Iₒ+kΔIₒ, to maximize overall system output given Iₒ (620). If the power Pₒ is increasing then algorithm can determine the current Iₒ was changed, e.g., stepped up or down, by the DPP 32 in the correct direction. If the power Pₒ is decreasing, then the sign of k can be changed to move the current Iₒ in the other direction.

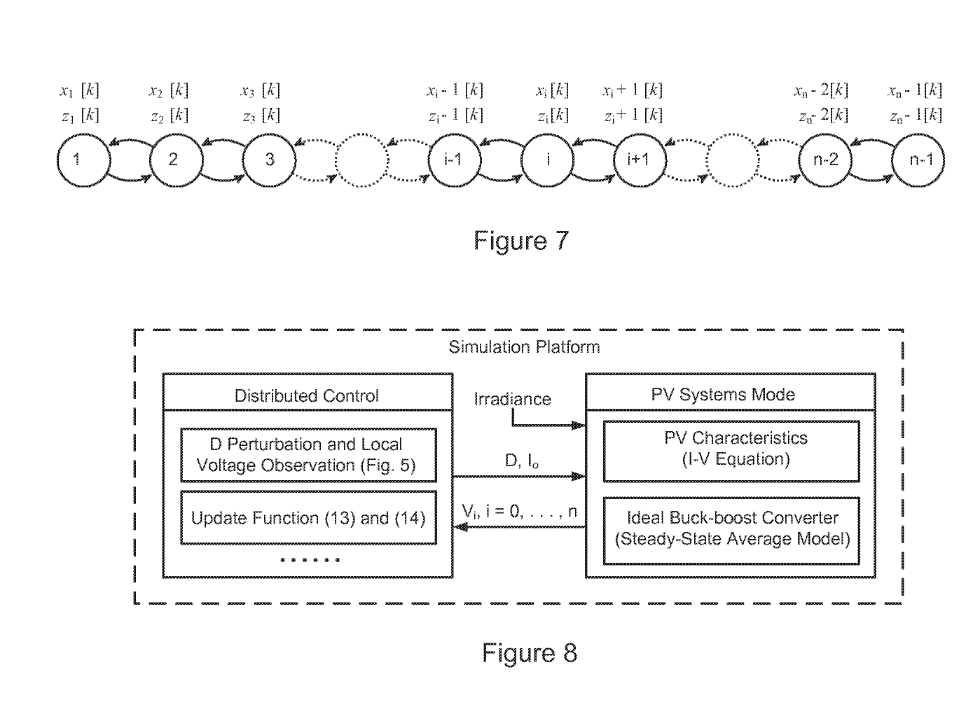

FIG. 7 is a graph of an example n-sub-module, (n−1)-DPP system. For a system of n sub-modules 30 and n−1 DPP converters 32, the communication graph shown in FIG. 7, the state vector, and the ancillary state vector of the entire system can be determined as:

x[k]=[x₁[k]x₂[k] . . . xᵢ[k] . . . xₙ₋₁[k]]^{T}, (7)

z[k]=[z₁[k]z₂[k] . . . zᵢ[k] . . . zₙ₋₁[k]]^{T}, (8)

where xᵢ[k] and zᵢ[k], i=1, 2, . . . , n−1, are state vectors maintained by the local controller of DPPⁱ. Each local controller maintains an estimate of the duty ratios of all other DPPs in addition to its own; thus, xᵢ[k] includes \hat{D}_{i,j}[k], i, j=1, . . . , n−1, i≠j and Dᵢ[k], e.g.,

xᵢ[k]=[\hat{D}_{i,1}[k], . . . ,Dᵢ[k], . . . ,\hat{D}_{i,n-1}[k]]^{T},

zᵢ[k]=[z_{i,1}[k],z_{i,2}[k], . . . ,z_{i,n-1}[k]]^{T}.

Also determine the input vector as:

$$\begin{matrix}u [ k ] = {[ \begin{matrix}\frac{\partial {ϕ}_{1} ( D )}{\partial D} & \frac{\partial {ϕ}_{2} ( D )}{\partial D} & … & \frac{\partial {ϕ}_{n - 1} ( D )}{\partial D}\end{matrix} ]}^{T} , \\ where & ( 9 ) \\ \frac{\partial {ϕ}_{i} ( D )}{\partial D} = {[ \frac{\partial {ϕ}_{i} ( D )}{\partial {D}_{1}} , \frac{\partial {ϕ}_{i} ( D )}{\partial {D}_{2}} , … , \frac{\partial {ϕ}_{i} ( D )}{\partial {D}_{n - 1}} ]}^{T} , & ( 10 )\end{matrix}$$

with φᵢ(D) given by

$${ϕ}_{i} ( D ) = \{ \begin{matrix}{V}_{i} ( D ) + \frac{1}{2} {V}_{i + 1} ( D ) , & i = 1 \text{,} 5 pt \\ \frac{1}{2} {V}_{i} ( D ) + \frac{1}{2} {V}_{i + 1} ( D ) , & 1 < i < n - 1 \text{,} 5 pt \\ \frac{1}{2} {V}_{i} ( D ) + {V}_{i + 1} ( D ) , & i = n - 1.\end{matrix} \qquad ( 11 )$$

Then, at each iteration, similar to (5) and (6), the variables are updated as:

x[k+1]=(I₍ₙ₋₁₎_{²}−δ\tilde{L})x[k]−δ\tilde{L}z[k]+δγu[k], (12)

z[k+1]=z[k]+δ\tilde{L}x[k], (13)

where I₍ₙ₋₁₎_{²} is the (n−1)×(n−1) identity matrix; \tilde{L}=L [symbol] Iₙ₋₁, where L is now the Laplacian matrix of the graph in FIG. 7:

$$L = [ \begin{matrix}1 & - 1 & 0 & … & … & 0 \\ - 1 & 2 & - 1 & 0 & … & 0 \\ 0 & - 1 & 2 & - 1 & ⋱ & ⋮ \\ ⋮ & ⋱ & ⋱ & ⋱ & ⋱ & ⋮ \\ ⋮ & ⋱ & ⋱ & - 1 & 2 & - 1 \\ 0 & ⋯ & ⋯ & ⋯ & - 1 & 1\end{matrix} ] .$$

By inspecting (12) and (13) for the n-sub-module case, the state of DPPⁱ at instant k+1, xᵢ[k+1] and zᵢ[k+1], depends on its own state at instant k, xᵢ[k] and zᵢ[k]; the states of its neighboring DPPs at instant k, e.g., xᵢ₋₁[k], zᵢ₋₁[k], xᵢ₊₁[k], zᵢ₊₁[k], all of which can be acquired through the neighbor-to-neighbor communication; and uᵢ[k], which is approximated by DPPⁱ as

$$\frac{{Δϕ}_{i} ( D )}{Δ D} .$$

Similar to the 2-DPP case, after k=m iterations, for m sufficiently large, providing Dᵢ[m]≈Dᵢ^{*}, i=1, 2, . . . , n−1.

Note that although the algorithm update functions are compactly written in matrix form in (12) and (13), the actual data storage and computation is distributed among the DPPs. To understand how this algorithm is distributed, consider DPPⁱ (nodeⁱ) in FIG. 7 as an example. DPPⁱ locally stores and updates vector xᵢ[k] and zᵢ[k] that are part of (7) and (8), respectively. For the computation performed by DPPⁱ, only the i^{th} row of Laplacian matrix L (representing the information exchange of DPPⁱ with its closest neighbors) is relevant. If (12) and (13) are expanded, and write down only the part needed to compute xᵢ[k+1], obtain:

xᵢ[k+1]=δxᵢ₋₁[k]+(1−2δ)xᵢ[k]+δxᵢ₊₁[k]+

δzᵢ₋₁[k]−2δzᵢ[k]+δzᵢ₊₁[k]+δγuᵢ[k],

zᵢ[k+1]=zᵢ[k]−δxᵢ₋₁[k]+2δxᵢ[k]−δxᵢ₊₁[k],

which illustrates that the computation of xᵢ[k+1] can be performed independently by DPPⁱ as long as this DPP converter has access to the state of its closest neighbors, e.g., achieved in practice through neighbor-to-neighbor communications. Other states of the system are irrelevant to DPPⁱ's computation. A similar conclusion applies to other DPP converters 32; therefore, each DPP converter performs only part of the update computation relevant to itself, and thus the systems, methods and algorithm are distributed.

FIG. 8 is a block diagram of components for an example simulation platform. MATLAB can be used as the platform for the numerical simulations. In FIG. 8, the simulation platform includes two independent parts: the PV system model block and the control block. The PV system model contains a set of equations that describes the electrical behaviors of the sub-modules 30 and the DPP converters 32. The I-V characteristic of each PV sub-module is described using the non-linear equations. The buck-boost converter are modeled using the steady state average equations. Each converter takes a duty ratio command from the control block and enforces a corresponding voltage ratio between two neighboring PV sub-modules 30, and the Newton-Raphson method is applied to solve the set of equations of the PV system model. The control block of FIG. 8 runs the distributed algorithm described above. During each control algorithm iteration, the control block passes duty ratio commands to the PV system block, which solves the system variables and returns the voltage information to the control block. The control block then uses the voltage information to calculate the update function, after which it starts a new iteration. Parameters in the control algorithm or the irradiance condition of PV sub-modules 30 can be set before the simulation or changed during the simulation to study various situations.

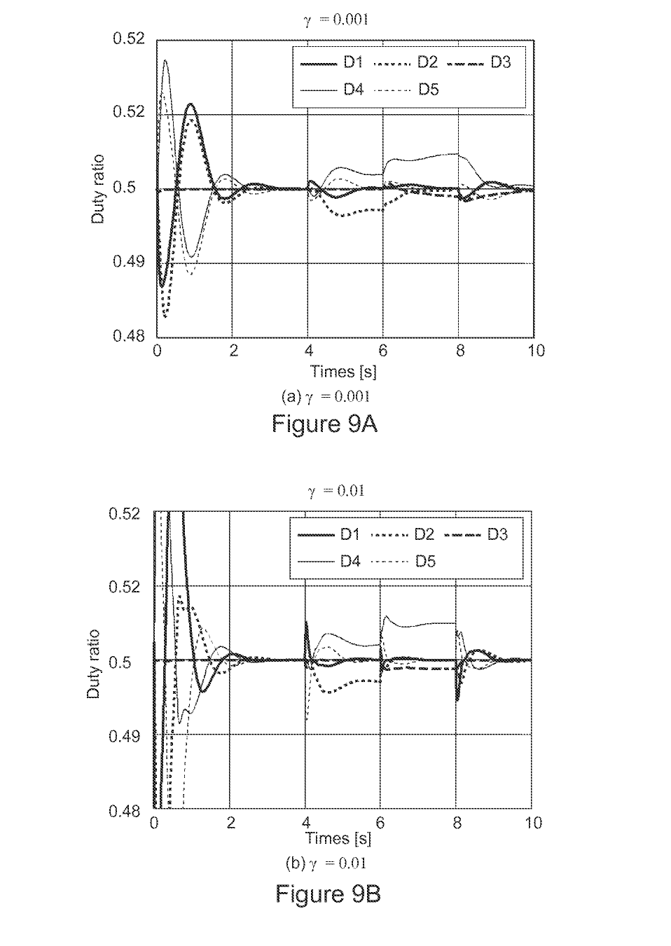

FIG. 9A and FIG. 9B are graphs of an example evolution of duty ratios determined by the distributed algorithm for the system, with fixed γ for a 6-sub-module, 5-DPP system. In (5), the parameter γ determines the influence that the input vector u[k] has on the state vector x[k]. Typically a relatively large value of γ renders a shorter response time but larger transient overshoot of duty ratios. As an example, FIG. 9A and FIG. 9B show the duty ratio of a 6-sub-module, 5-DPP system evolving over time with different values of γ in the update function; the normalized irradiance profile used in this example is as follows:

$$\{ 100 \% , 100 \% , 100 \% , 100 \% , 100 \% , 100 \% \} {}^{t = 4 s} \{ 100 \% , 100 \% , 80 \% , 80 \% , 50 \% , 50 \% \} {}^{t = 6 s} \{ 100 \% , 100 \% , 100 \% , 80 \% , 50 \% , , 50 \% \} {}^{t = 8 s} \{ 100 \% , 100 \% , 100 \% , 100 \% , 100 \% , 100 \% \} , \qquad ( 14 )$$

with step changes occurring at t=4 s, 6 s, 8 s as indicated. As shown in FIG. 9A and FIG. 9B, for different values of γ, the algorithm converges to the same steady-state value after each irradiance change. Compared to other transients, the duty ratio overshoot is very large at a “cold start”, which corresponds to t=0 s in FIG. 9B. At “cold start”, the algorithm can be activated without receiving any information of the system. Although the entries of x[k] can be initialized to 0.5, the entries of z[k] can only be initialized to 0. Since z[k] is intended to balance the input vector u[k] in (5), the state vector x[k] is very sensitive to u[k] when z[k] is small; in this case, a smaller γ is preferable to suppress the overshoot. Note that the slow convergence resulting from this small γ is not a problem since, in the field, “cold start” conditions correspond to turning on the DPP system, which typically happens only once per day. Once the system converges and z[k] reaches steady state, a small γ is undesirable due to its slow response, and a larger γ can be used for faster tracking upon irradiance changes (also referred to as “hot start”). Duty ratio overshoot in a “hot start” condition is typically small despite a large γ since the z[k] has already reached a steady state value. Therefore, some on-line tuning scheme for γ can be incorporated in the algorithm to improve its convergence properties.

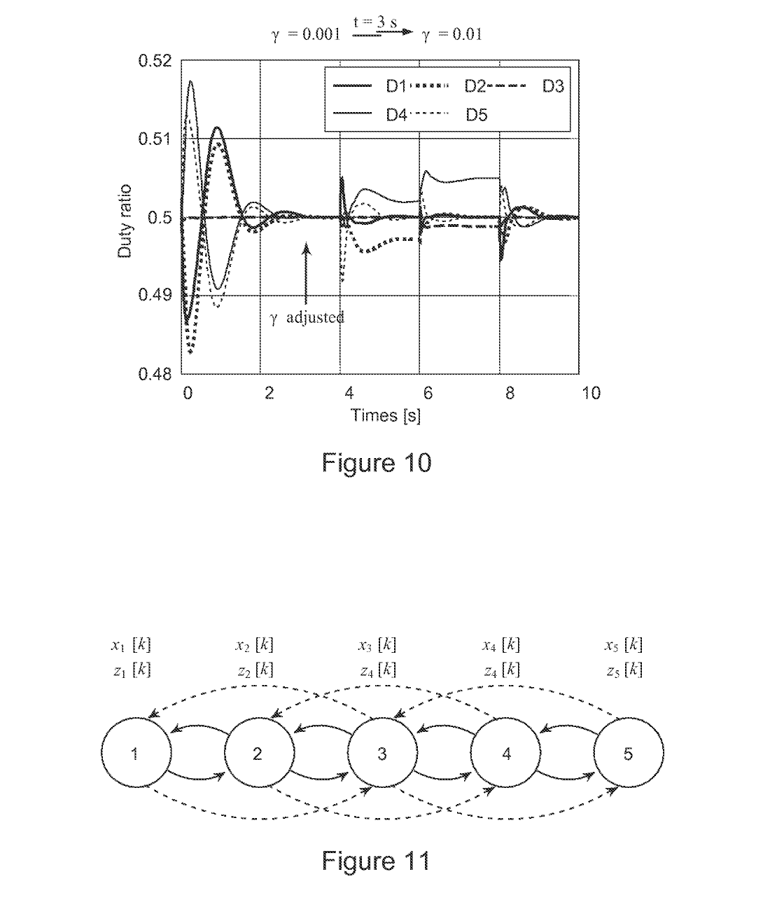

FIG. 10 is a graph of an example evolution of duty ratios determined by the distributed algorithm for the system, with adaptive γ for a 6-sub-module, 5-DPP system. To develop a method for smoothly changing the value of γ without introducing any disturbance to the duty ratio, note that after the algorithm converges to a steady state value, providing:

x[k+1]=x[k]=x*, (15)

z[k+1]=z[k]=z*. (16)

Substituting (15) and (16) in (12) and (13), respectively, yields

\tilde{L}z*=γu*, (17)

\tilde{L}x*=0, (18)

which suggests that scaling γ and z* by the same multiplicative constant does not affect the equilibrium point of the algorithm. Therefore, the on-line tuning scheme can modify γ without introducing a disturbance on the duty ratio as long as z[k] is simultaneously changed by the same scaling factor. In FIG. 10, the response of a 5-DPP system after such a tuning scheme is applied. The system “cold starts” with a small γ, and modifies the value of γ at t=3 s without any noticeable disturbance to the duty ratios. The transient effects of irradiance changes in solar PV applications can be used in the selection of γ for a suitable balance between speed and accuracy.

Similar to the choice of γ, the choice of 5 in (12) and (13) can also be increased to speed up the convergence of the algorithm. While γ controls the update iteration of x[k] to x[k+1] by scaling the influence of the gradient step as determined by u[k], e.g., the larger the value of γ is, the larger the update of x[k] to x[k+1] will be, δ also scales the influence of the gradient step as determined by u[k]; but it also scales the influence of the auxiliary variable \tilde{L}z[k]; however, the signs of these terms are opposite, so it is not clear a priori which term will have more influence. On the other hand, δ is also the time elapsed between two consecutive iterations k and k+1; thus, by increasing δ, the iteration time is reduced proportionally. When choosing δ, there may be a trade-off between speed and stability of the algorithm. Because the system is highly non-linear, δ can only be determined empirically, and δ can be kept smaller than 0.1 to guarantee stability in most scenarios.

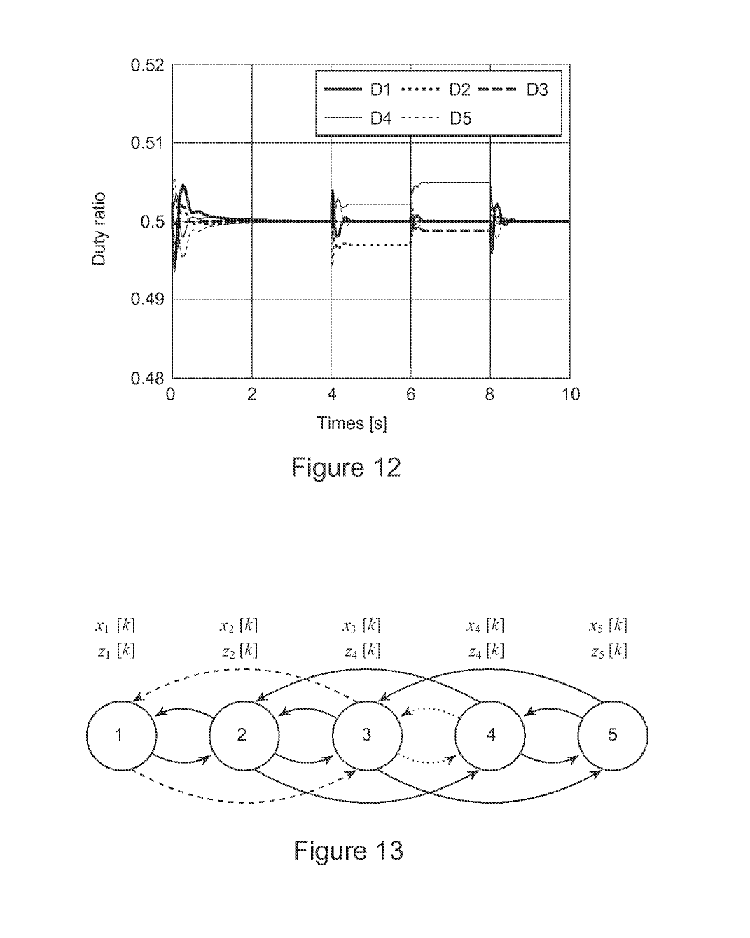

FIG. 11 is a graph of an example 6-module, 5-DPP system with redundant communications. The convergence speed of the algorithm may be improved by modifying the communication topology. In FIG. 11, a directed graph represents the communication topology of a 6-sub-module, 5-DPP system. The same irradiance pattern in (14) is applied to the 6 sub-modules 30. By relying only on neighbor-to-neighbor communication (as captured by the solid line in FIG. 11), the evolution of duty ratios is relatively slow as has already been shown in FIG. 10. If redundancy is introduced to the communication topology, e.g., each DPP can communicate with its second closest neighbor(s) in addition to its direct neighbor(s) (as captured by the dashed line in FIG. 11), the convergence speed can be accelerated (as in FIG. 12) and the algorithm can be easily adapted to accommodate this change. The Laplacian matrix L is modified in the update functions in (12) and (13) to reflect the new communication topology, which in this case is given by:

$$L = [ \begin{matrix}2 & - 1 & - 1 & 0 & 0 \\ - 1 & 3 & - 1 & - 1 & 0 \\ - 1 & - 1 & 4 & - 1 & - 1 \\ 0 & - 1 & - 1 & 3 & - 1 \\ 0 & 0 & - 1 & - 1 & 2\end{matrix} ] . \qquad ( 19 )$$

FIG. 12 is a graph of an example evolution of duty ratios computed by distributed algorithm with communication failure reconfiguration. Besides L, no further modification to the algorithm is necessary. In FIG. 12, the extra communication links significantly improve convergence speed. Further simulation indicates that as more communication links are added, the convergence speed of the algorithm further increases. Although it seems that additional communication hardware is required in the real system to introduce the modification as discussed above, this is not really the case. As described below, the hardware design, which integrates 3 DPPs on one printed circuit board (PCB), readily lends itself to the communication topology in which each DPP can communicate with at least its first, second, and third neighbors in both directions without additional hardware.

FIG. 13 is a graph of an example 6-submodule, 5-DPP system with communication failure. The distributed algorithm converges to the optimal solution as long as the directed graph describing the communication topology remains strongly connected. Therefore, when the communication topology has redundancy, the algorithm can be reconfigured to work under communication link failures. Consider the 6-sub-module, 5-DPP system with the communication topology in FIG. 13. Each DPP is communicating with its first and second closest neighbors. The Laplacian matrix of this graph is given in (19). If a communication link fails as illustrated by the dashed lines in FIG. 13, and this failure is detected by the local controllers of the DPPs on each end of the link, the two controllers involved can simply reconfigure the algorithm by modifying the corresponding row of the Laplacian matrix used in their update function to reflect this change in the communication topology. Thus, the new Laplacian matrix can be given by:

$$L = [ \begin{matrix}1 & - 1 & 0 & 0 & 0 \\ - 1 & 3 & - 1 & - 1 & 0 \\ 0 & - 1 & 3 & - 1 & - 1 \\ 0 & - 1 & - 1 & 3 & - 1 \\ 0 & 0 & - 1 & - 1 & 2\end{matrix} ] ; \qquad ( 20 )$$

note that only the first and third row in the Laplacian matrix change. This change is completely local to the two DPPs on the ends of the failed communication link, e.g., DPP₁ and DPP₃, and affects only the update functions of these two DPPs. The update functions for other DPPs remain the same and continue to perform MPPT, since other rows of the Laplacian matrix do not change. If another communication failure occurs after the first one, e.g., as illustrated by the dotted line in FIG. 13, the Laplacian matrix can be modified again; this results in:

$$L = [ \begin{matrix}1 & - 1 & 0 & 0 & 0 \\ - 1 & 3 & - 1 & - 1 & 0 \\ 0 & - 1 & 2 & 0 & - 1 \\ 0 & - 1 & 0 & 2 & - 1 \\ 0 & 0 & - 1 & - 1 & 2\end{matrix} ] . \qquad ( 21 )$$

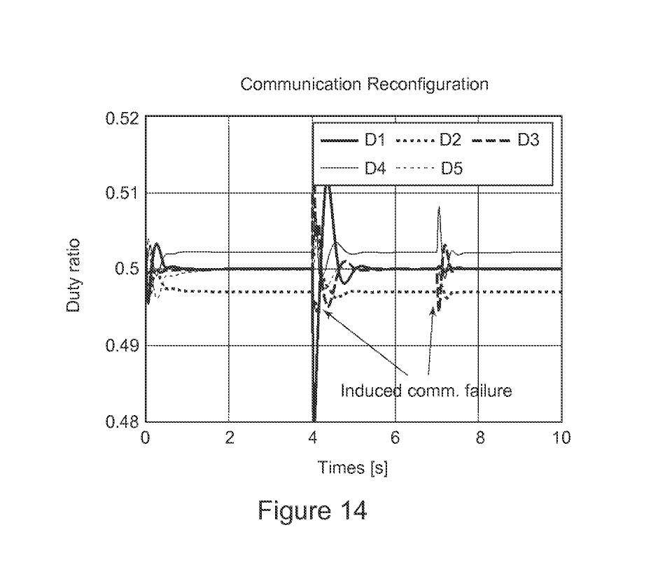

FIG. 14 is a graph of an example evolution of duty ratios determined by the distributed algorithm with communication failure reconfiguration. In FIG. 14, the simulation result of this reconfiguration assuming unchanged irradiance pattern and the aforementioned communication link failures happening at t−4 s and t=7 s, respectively. As the simulation shows, after each communication failure, the algorithm is able to restore the duty ratio back to the optimal value after a short transient.

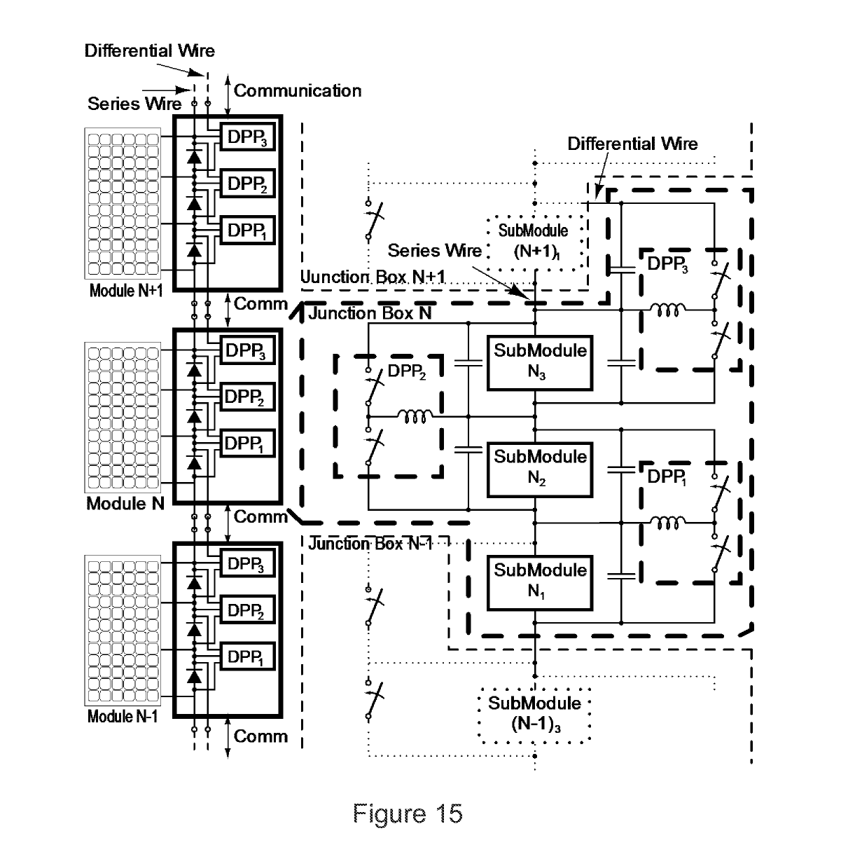

FIG. 15 is a circuit diagram of an example PV junction box connection for DPP system. A goal of distributed power electronics for PV systems, including DPP-based systems, is to achieve PV module integration. The cost of separate enclosures for distributed power electronics represents can be significant portion of the total system cost, motivating efforts to reduce the converter footprint to fit into the existing weather-resistant junction box of an off-the-shelf PV module. Therefore, for sub-module DPP systems, a goal of the hardware design is to achieve miniaturization of the DPPs for junction box integration, while maintaining high efficiency and capability for the implementation of the distributed MPPT algorithm.

In FIG. 15, an example wire connection is shown of a DPP system; typically one PV module includes three sub-modules 30. Therefore, each junction box integrates three DPPs. Between adjacent junction boxes there are three wire connections: one series string connection in which the bulk power common to all sub-modules 30 flows, one differential connection through which the DPPs shuffle the small power mismatch, and one or more wires for communication. In some implementations, the bulk and differential power wires can be used for communication purpose.

The DPPs can be implemented as bidirectional synchronous buck-boost converters. The buck-boost topology allows for the use of low-voltage, fast-switching transistors. By employing a high switching frequency in the order of hundreds of kHz, the size of the magnetic components, which typically dominate the converter size, can be significantly reduced. Furthermore, each micro-controller can have enough peripherals to control more than one DPP. Moreover, since the 3 DPPs in one junction box are physically very close, they can be integrated on one PCB and controlled by one micro-controller. This eliminates the need for communication between DPPs in one junction box and reduces the control overhead in terms of hardware cost and power consumption. A low-cost 32-bit ARM Cortex-M3 micro-controller can be used, which also allows some flexibility for expansions, e.g., implementation of fault detection algorithms. Each DPP is constructed with a shielded power inductor and an integrated DRMOS power stage to achieve high efficiency and a very small footprint on the PCB; Table 2 contains a list of example components used.

TABLE 2
Example component List

| Device | Model | Value | | Manufacturer |
|---|---|---|---|---|
| Micro- | STM32F105 | | | STMicro- |
| controller | | | | electronics |
| DRMOS | SiC780 | | | Vishay |
| Linear | UA78L05CPK | | | Texas Instrument |
| Regulator | | | | |
| L | SER1360-103KL | 10 | μH | Coilcraft |
| C | TMK212BBJ106KG-T | 10 | μF × 4 | Taiyo Yuden |
| D_{shift} | 1SS416CT(TPL3) | | | Toshiba |
| C_{shift} | 0402 | 4700 | pF | |
| R_{shift} | 0402 | 100 | kΩ | |
| I² C Isolator | ADuM1250 | | | Analog Devices |

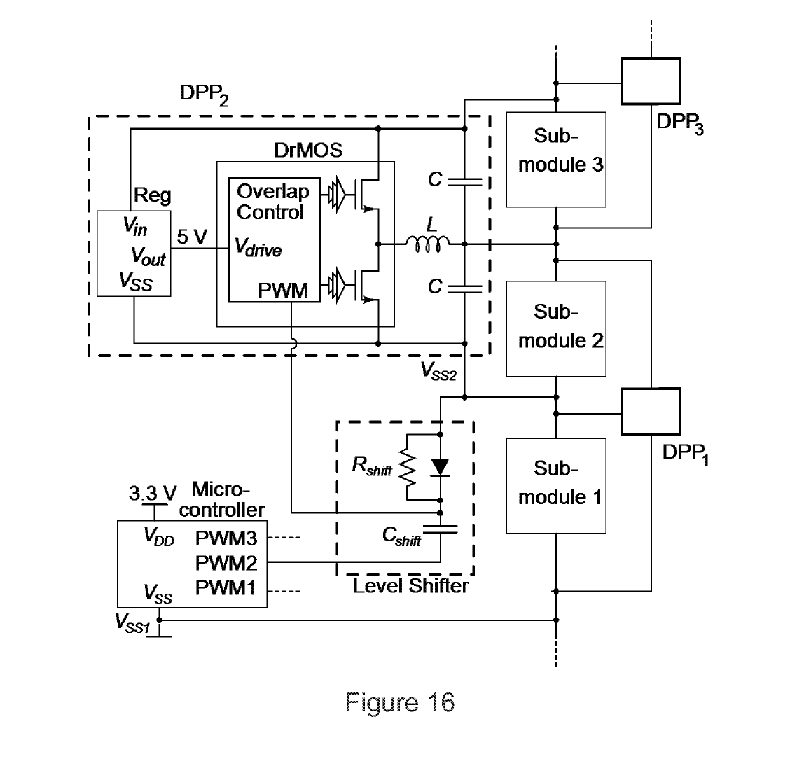

FIG. 16 is a schematic of an example hardware design shown for DPP₂. DPP₁ and DPP₃ can be similar. A challenge of controlling 3 DPPs with one micro-controller is sending the control signal across different voltage levels. In FIG. 16, while DPP₁ can be controlled directly by the micro-controller, the PWM control signals sent to DPP₂ and DPP₃ are level shifted because they do not have the same voltage reference as the micro-controller. The level shifting circuitry can be implemented using low-cost passive devices (R_{shift}, C_{shift} and D_{shift} in FIG. 16). When the micro-controller PWM₂ signal is low, the level shifting capacitor gets charged to the voltage difference between the ground potential of DPP₂ and the ground potential of the micro-controller through the diode. The PWM input pin of DPP₂'s DRMOS is thus pulled to DPP₂'s ground potential. When the micro-controller PWM₂ signal reaches the high-voltage limit (3.3 V), the voltage of the DRMOS's PWM input pin is pushed to its high-voltage limit (3.3 V) with respect to DPP₂'s ground reference, and the diode turns off. Since the PWM input pin of the DRMOS has a high impedance, any current that flows through the level shifting capacitor is very small, so the input voltage to the DRMOS's PWM input pin can remain high for a long enough time before PWM₂ goes low again. A resistor is placed in parallel with the diode to prevent over-voltage across the PWM input pin due to a sudden decrease of sub-module 1 voltage, e.g., the voltage difference between DPP₂'s ground reference and the micro-controller's ground reference. Certain considerations can be used when selecting the value of level-shifting capacitors and resistors; factors to consider include the time constant of the level shifter compared to the PWM frequency, and the driving capability of micro-controller PWM pins. For protection of the micro-controller PWM pin, a small value resistor can be placed in series with the level-shifting capacitor to reduce current spike during start-up. In one example, magnetic inductors are on the back side of the PCB. Essential components of the hardware, including the inductors on the back side of the PCB, can only take up a 3.75 cm×3.75 cm area encompassed by a white rectangle, and can easily fit in a junction box.

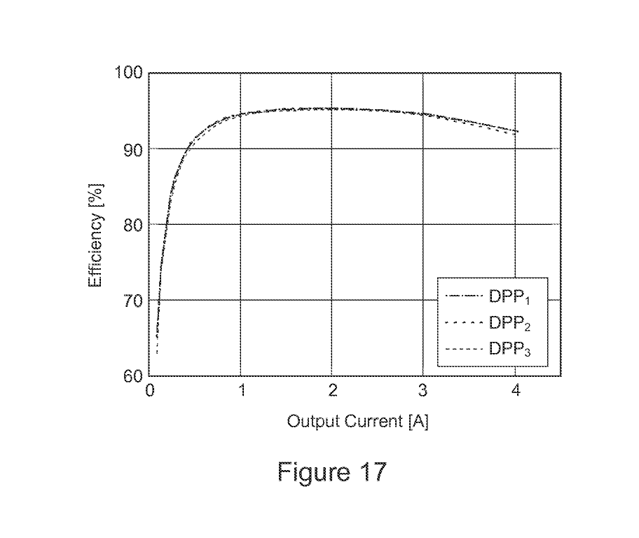

FIG. 17 is a graph of an example measure efficiency of the 3 DPPs on one hardware prototype at 10 V input voltage, 50% duty ratio. A potential limitation of the digital PWM signal generated by the micro-controller is that with limited clock frequency, a trade-off has to be made between PWM frequency and PWM resolution. The PWM frequency is determined by the requirement of high efficiency and small converter size, so it is maintained at a relatively high value (e.g., 100 kHz), rendering a low PWM resolution given the limited micro-controller frequency. In each iteration of the MPPT algorithm discussed above, the duty ratio updates that are calculated with high precision are quantized to within the PWM resolution, which can impair an effectiveness of the algorithm. To overcome this, a PWM dithering technique can be adapted. By dithering periodically between two adjacent quantized duty ratio values available from the micro-controller, with proper filtering, the effective PWM resolution in the hardware prototype is increased by about ten times. The effective PWM resolution and other example specifications of the hardware prototype are listed in Table 3. Note that the DPP converter peak efficiency is above 95%. An efficiency characterization of the DPP converter across the entire load range is shown in FIG. 17. Note that the relatively low light load efficiency can be greatly improved using pulse frequency modulation (PFM) techniques.

TABLE 3
Example components

| Sub-module Voltage Range | 3-134 V Should be 13.4 V | |
|---|---|---|
| Converter Power Rating | 60 | W |
| Switching Frequency | 100 | kHz |
| Duty Ratio Resolution (with PWM | 1/3600 | |
| dithering) | | |
| Converter Peak Efficiency | 95% | |
| Weight | 28 | g |
| Volume | 8.575 | cm³ |

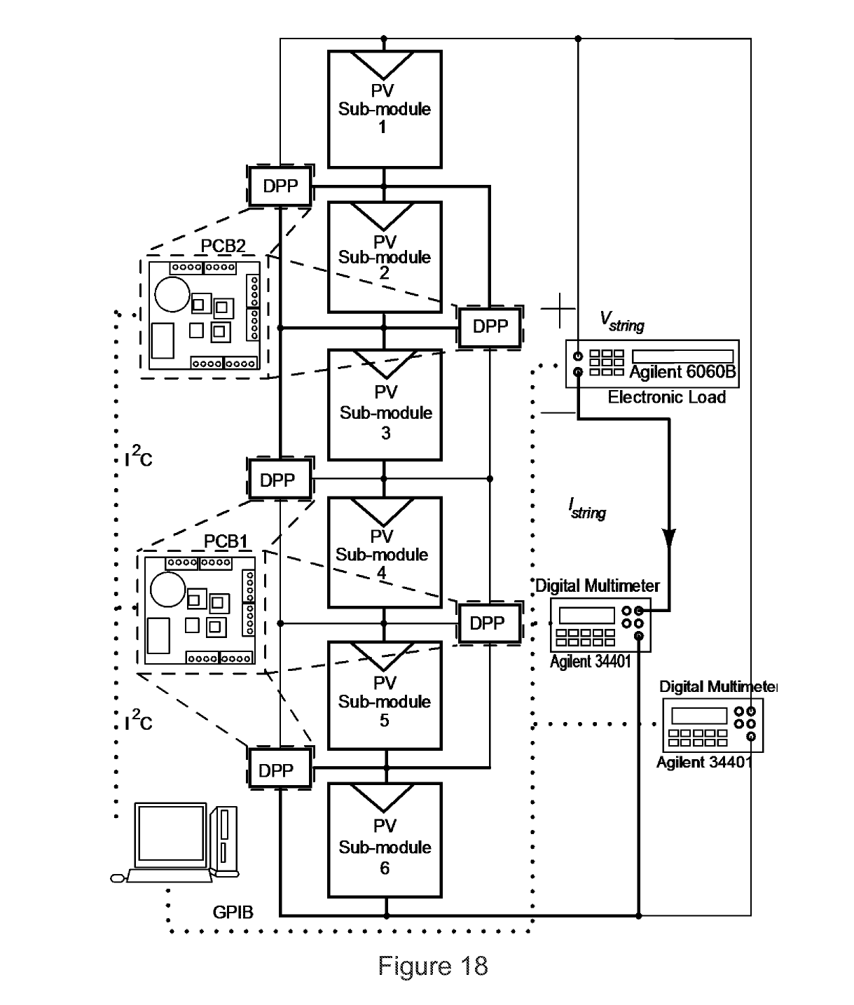

FIG. 18 is a block diagram of an example setup. A power supply (HP 6631A) is connected in parallel with each PV sub-module to replicate the photo-generated current, providing an output I-V characteristic similar to the one that would result if the PV sub-module were to be illuminated by sunlight. Five DPPs implemented on 2 prototype boards are connected in parallel with a string of six PV sub-modules 30. Three of them are from a SUNMODULE SW 235 Poly PV modules, and the other three are from a SOLARWORLD SUNMODULE SW 245 Poly PV modules. These two modules are manufactured in the same process, but binned into two different models by the manufacturer for better characteristics matching. In one example, they are chosen intentionally to illustrate that PV modules 10 which undergo a less stringent binning process and thus have more mismatch can benefit from the algorithm. An electronic load (Agilent 6060B) acts as a central converter and controlled the string current. Two digital multimeters (Agilent 34401) are used to measure the string voltage and current. Power supplies, digital multimeters and the electronic load communicated with a computer, e.g., through a general purpose interface bus (GPIB) interface. Micro-controllers on the two prototype boards communicated with each other and with the same computer through an I²C interface. Note that the computer received information from the micro-controllers for data logging and diagnostic purposes. The distributed algorithm, including data exchange and synchronization at each iteration, is fully implemented in the micro-controllers.

In the example, the current limits of the power supplies are set to certain percentages of the sub-modules' 30 nominal short-circuit current to emulate the corresponding percentage of irradiance (e.g., a combination of 5 A, 4 A and 2.5 A is used to emulate an irradiance profile of 100%, 80% and 50% normalized value). For a given irradiance mismatch scenario, the string current is kept fixed at a certain value by the electronic load to emulate the behavior of a central inverter during its P&O interval. The evolution of duty ratios of all DPPs, along with the string current and voltage after the convergence of the algorithm, is recorded by the computer.

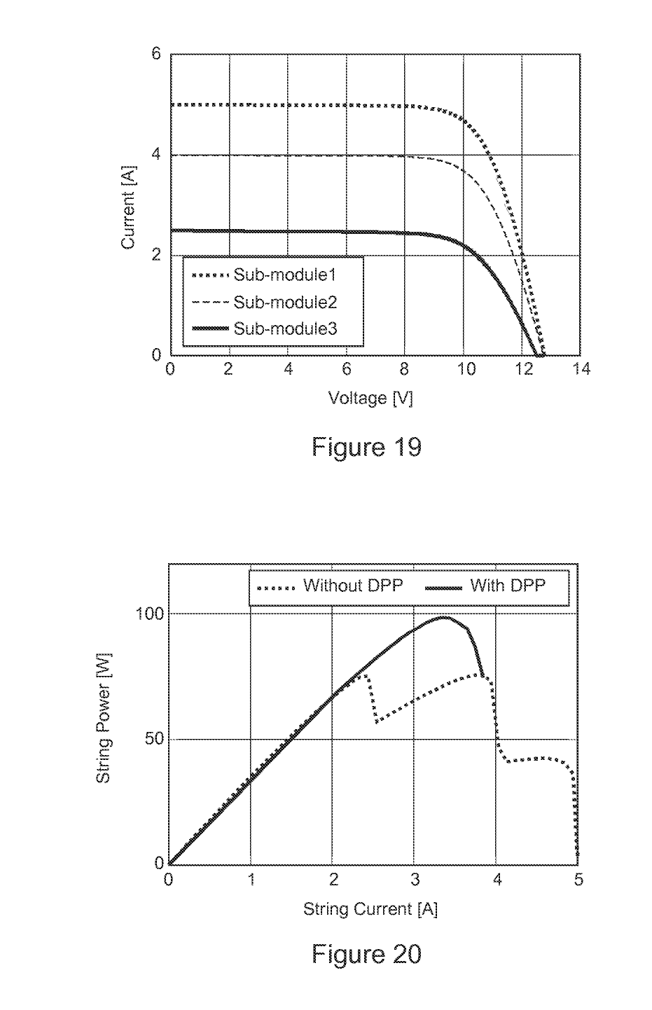

FIG. 19 is a graph of an example I-V characteristics of 3 sub-modules 30 with 100%, 80% and 50% normalized irradiance. In the 2-DPP case, 3 sub-modules 30 are set up and compared the data with a MATLAB simulation. The irradiance pattern, string current, and initial duty ratios can be set to be the same in the example, and the evolution of the states of the algorithm recorded, under different conditions. A good matching can be found between simulation and experimental data. For example, a condition with 100%, 80%, 50% normalized irradiance on sub-modules 30 1, 2 and 3, respectively (FIG. 19 shows the measured corresponding I-V curves). The electronic load in FIG. 18 is programmed to initially perform a reference string current sweep, where the DPP converters 32 were not operating. Following this, a string current sweep can be performed with the DPP converters 32 operating, executing the algorithm. The DPP converters 32 are allowed time for 200 iterations, which is enough time for the algorithm to converge to maximize the string voltage for that particular string current.

FIG. 20 is a graph of an example string P-I characteristics of a 2-DPP system with irradiance pattern of 100%, 80% and 50%. An example result of the string current sweeps is shown in FIG. 20. The DPP converters 32 running the algorithm smoothed out the P-I characteristics of the mismatched PV string and eliminated the local maxima. Therefore, a central inverter running the current referenced P&O method can converge to the optimal current given the concave P-I characteristics of the PV string with DPP converters 32.

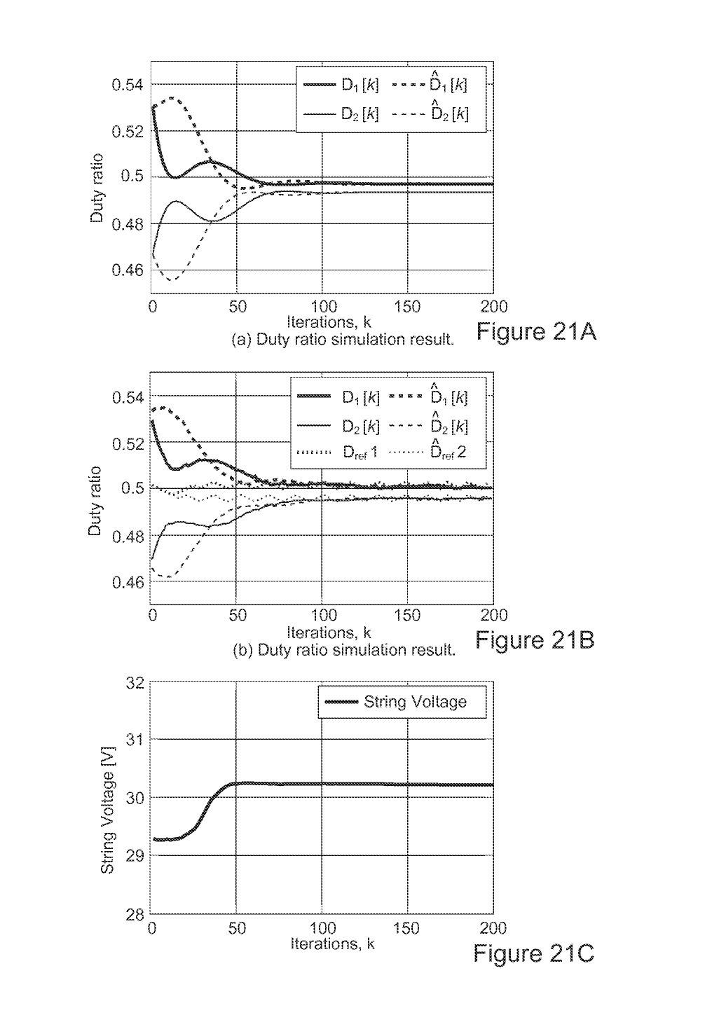

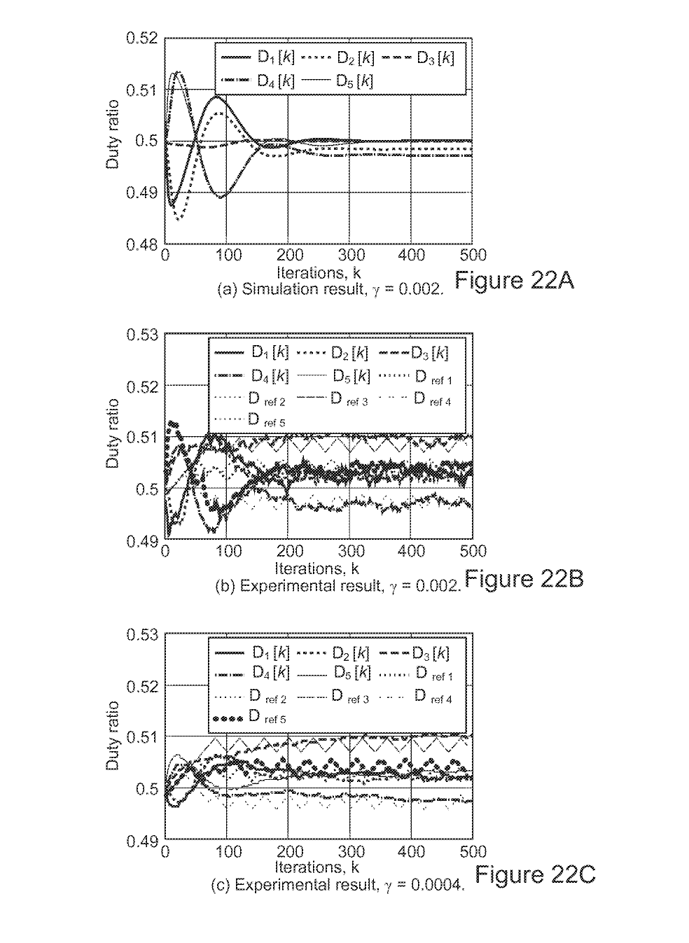

FIGS. 21A-C are graphs of example evolution of duty ratios computed by the distributed algorithm for a 2-DPP system, with irradiance pattern of 100%, 80%, 50%, I_{string}=3.3 A, δ=0.1 and γ=0.003. Example experimental results of the evolution of the centralized algorithm is also plotted in dotted lines in as a benchmark reference for the final value after convergence. The string voltage change in the example as a result of the evolution of the distributed algorithm is also plotted. To illustrate the operation of the DPP control algorithm, consider one situation in the current sweep as an example. When the string current is 3.3 A (corresponding to the global maximum power), FIG. 21A shows the evolution of the simulated duty ratios for this condition; FIG. 21B shows the evolution of the duty ratios computed using the experimental setup with the same condition. As the figure shows, the state variables in both simulations and examples quickly converge and roughly follow the same trajectory (also note that the duty ratios D₁[k] and D₂[k] settle to the same value as corresponding duty ratio estimates \hat{D}₁[k] and \hat{D}₂[k]). To verify that the algorithm converges to the correct value, on the experimental setup, the centralized MPPT algorithm can be executed, and its duty ratio evolution recorded as a benchmark (e.g., D_{ref1} and D_{ref2} in FIG. 22B). The final duty ratios of the algorithm after convergence can be almost identical to those of the centralized MPPT algorithm. The string voltage is measured as the distributed algorithm converged, as shown in FIG. 22C, which can confirm the increase in string voltage. Tests of other irradiance patterns and string current can exhibit similar results.

FIGS. 22A-C are an example evolution of duty ratios computed by distributed algorithm for a 5-DPP system with irradiance pattern of 100%, 100%, 80%, 80%, 50%, 50%, I_{string} 3.3 A, δ=0.1 and different γ. Example results of the evolution of the centralized algorithm is also plotted in dotted lines as a benchmark reference for the final value after convergence. Similar to the 2-DPP case, a 5-DPP system can be tested for different conditions. String current sweeps are performed in the same way as described for the 2-DPP system. The P-V characteristics are similar to that of the 2-DPP system. One string current value is taken in the current sweep steps as an example. FIGS. 22A and B show the simulation and experimental result for the same conditions and initial duty ratios. Note that among all the state variables, only the actual duty ratios Dᵢ[k], i=1, 2, . . . , 5, are plotted (the corresponding \hat{D}ᵢ[k] s are omitted). Along with the distributed MPPT algorithm, a centralized MPPT algorithm is also executed, and its evolution is plotted in FIG. 22B as the benchmark. As the algorithm converged, an increase in string voltage can be experimentally measured, with similar characteristics as the 2-DPP case. Note that in both the 2-DPP and the 5-DPP systems, states in simulation and example can follow very similar trajectories but do not converge to exactly the same final values; this may be primarily due to two reasons. First, a simulation does not take into account the converter power losses. Second, as two types of PV modules 10 are used in the example to emulate modules with less stringent binning, there is some variation in the I-V curves of the six sub-modules 30, which is not captured in the simulation.

The algorithm and the centralized MPPT algorithm converge to the same final value. However, due to the noise in the voltage measurements, the duty ratio values still have small variations after convergence. With a smaller value of γ in (12), the variation around the steady-state value can be significantly reduced as Dᵢ[k] is less dependent on uᵢ[k], but the algorithm can take more iterations to converge to the steady state value, as shown in FIG. 22C, which is consistent with description above. In terms of hardware related issues, the noise in the voltage measurements can be reduced by averaging multiple reading, or filtering with larger capacitors at the ADC pins, which may increase the time needed for each iteration. Therefore, a trade-off between the convergence speed of the algorithm and the ‘noise’ in the steady state values can be considered in the implementation.

To further verify that the algorithm effectively tracked the maximum power point, the static tracking efficiency can be measured, determined as the ratio of the actual power extracted to the maximum power of each sub-module for a given irradiance, when the string current is at the optimal value. To acquire the actual power extracted from each sub-module, two digital multi-meters (Agilent 34401) to perform synchronized can be used, fast (0.006 NPLC) measurements on the current and voltage of each sub-module after the algorithm converged (the algorithm was kept running), so the tracking efficiency losses due to duty ratio perturbations, switching ripples and other transients could be taken into account in these measurements. The measurements are performed 100 times continuously. Sub-module power can be calculated from each pair of current and voltage measurements, and averaged over the 100 times. To acquire the maximum sub-module power, an output voltage sweep can be performed on each sub-module under the same irradiance, and the maximum output power recorded. An example resulting tracking efficiency is determined as in in Table 4 for a few cases. As noted above, the six sub-modules 30 used in the example were from two PV modules 10. Due to the internal wiring of the PV modules 10 (three sub-modules 30 connected in series in the junction box), the current of the sub-module in the middle of each PV module was inaccessible, e.g., the current of sub-module 2 and sub-module 4 may not be directly measured when the algorithm is running. Therefore, only the power extracted from the other sub-modules 30 is measured.

TABLE 4
Example results

| | | |
|---|---|---|
| Irradiance Pattern | 100%, 100%, 80%, 80%, | 100%, 100%, 100%, |
| | 50%, 50% | 100%, 100%, 100% |
| Centralized MPPT | 0.503, 0.503, 0.508, | 0.499, 0.500, 0.502, |
| Duty Ratio | 0.497, 0.503 | 0.496, 0.501 |
| Distributed MPPT | 0.502, 0.502, 0.510, | 0.499, 0.499, 0.502, |
| Duty Ratio | 0.497, 0.504 | 0.496, 0.501 |
| Actual Sub-module | 45.42, N/A, 35.33, | 45.16, N/A, 44.96, |
| Power [W] | 36.59, N/A, 22.34 | 45.99, N/A, 46.54 |
| Maximum Sub-module | 45.89, 45.63, 35.56, | 45.89, 45.63, 45.39, |
| Power [W] | 36.67, 21.43, 22.35 | 46.06, 45.00, 46.71 |
| Tracking Efficiency | 98.98%, N/A, 99.35%, | 98.41%, N/A, 99.05%, |
| | 99.78%, N/A, 99.95% | 99.85%, N/A, 99.63% |

Another figure of merit is the dynamic MPPT efficiency of the system. The control of DPP converters 32 can work with an existing central inverter design and compensate the mismatch between sub-modules 30 in a PV array during partial shading, etc. While the DPP converters 32 can improve the dynamic MPPT efficiency of the entire system by compensating for sub-modules 30 mismatch, the dynamic efficiency of the system is determined and lower-bounded by the central inverter.

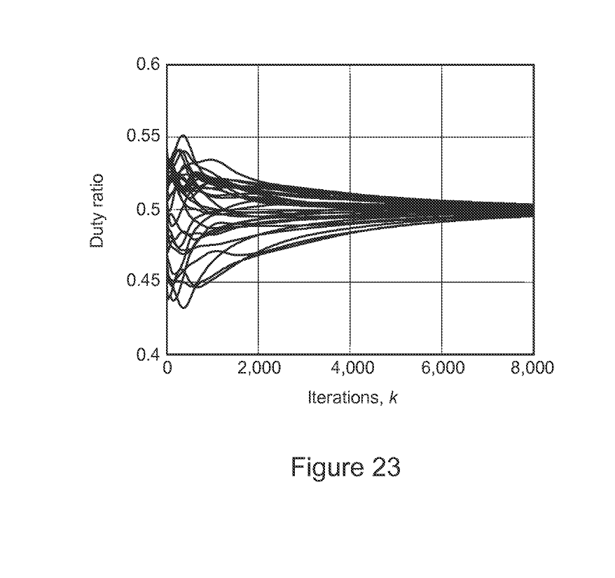

FIG. 23 is a graph of evolution of duty ratios computed by the distributed algorithm for 31-DPP simulation with 100% irradiance on all sub-modules 30 and random initial duty ratios. To demonstrate the scalability of the distributed MPPT algorithm, the simulation can be extended to model a system with 32 sub-modules 30 and 31 DPPs. The evolution of the duty ratios found by each of the DPP local controllers using the distributed algorithm is shown in FIG. 23, for randomly chosen initial conditions, and for an irradiance pattern in which all sub-modules 30 receive 100% irradiance. In FIG. 23, the algorithm converges to the expected solution wherein the duty ratios are Dᵢ=0.5, i=1, . . . , n−1. While more iterations are required for a larger system to converge from a random initial point, some of the terms in

$${u}_{i} [ k ] = \frac{\partial {ϕ}_{i} ( D )}{\partial {D}_{j}} \approx \frac{{Δϕ}_{i} ( D )}{Δ {D}_{j}} ,$$

as determined in (10), are effectively zero when i and j are far apart. This allows parallelization of DPP duty ratio perturbations to speed up the convergence.

A brief description of the mathematical background of the algorithm follows; B. Gharesifard and J. Cortes, “Distributed continuous-time convex optimization on weight-balanced digraphs,” IEEE Transactions on Automatic Control, VOL. 59, NO. 3, pp. 781-786, March 2014 contains more details.

To derive the algorithm, it can be started in the continuous-time framework, and the resulting dynamics discretized. Consider a network with n nodes, e.g., v₁, v₂, . . . , vₙ, whose communication topology can be described by a strongly connected digraph G, and each node vᵢ, iε{1, . . . , n} has a continuously differentiable and convex function ƒⁱ that is only available to this node, the unconstrained optimization problem:

$$min f ( {x}^{o} ) = {\sum }_{i = 1}^{n} {f}^{i} ( {x}^{o} ) \qquad ( 22 )$$

can be equivalently formulated as a constrained optimization problem

$$\begin{matrix}min \tilde{f} ( x ) = {\sum }_{i = 1}^{n} {f}^{i} ( {x}_{i} ) , & ( 23 ) \\ subject to \tilde{L} x = {0}_{n} , & ( 24 )\end{matrix}$$

where \tilde{L}=L [symbol] Iₙ; L is the Laplacian Matrix representing G, Iₙ is the n×n identity matrix, and “ [symbol] ” represents Kronecker product of L and Iₙ; 0ₙ is the n-dimensional all-zero vector; xⁱ is node vᵢ's estimate of the solution to (22), and x is a vector containing estimates from all nodes, e.g.,

x=[x₁^{T},x₂^{T}, . . . ,xₙ^{T}]^{T}. (25)

Then this constrained optimization problem can be solved using augmented Lagrangian method, e.g.,

min F(x,z)=\tilde{ƒ}(x)+z^{T}\tilde{L}x+½x^{T}\tilde{L}x, (26)

where z^{T} is the estimate of the Lagrange multiplier. To solve (26), find the point x*,z*) that sets the gradient of F(x,z) to zero, which can be obtained through the following dynamics:

\dot{x}+\tilde{L}x+\tilde{L}z=−∇\tilde{ƒ}(x), (27)

ż=\tilde{L}x. (28)

As (27) and (28) converge to the equilibrium point is the solution to (23), and x₁=x₂= . . . =xₙ in (25) is the solution to the original problem in (22).

In a DPP system setting, the control objective is:

$${maximize}_{{D}_{1} , … , {D}_{n}} V ( {D}_{1} , … , {D}_{n} ) = {\sum }_{i = 1}^{n} {V}_{i} ( {D}_{i} ) . \qquad ( 29 )$$

This control objective has the same separable structure as (22); thus tailor the algorithm in (27) and (28) to the setting. To this end, discretize (27) and (28) using the forward rectangular rule, e.g.,

$$\dot{x} = \frac{x [ k + 1 ] - x [ k ]}{δ} , \\ \dot{z} = \frac{z [ k + 1 ] - z [ k ]}{δ} . \qquad ( 30 )$$

Then by defining u=−∇\tilde{ƒ} (x), and substituting it and the expression in (30) into (27) and (28), obtain:

x[k+1]=(I₍ₙ₋₁₎_{²}−δ\tilde{L})x[k]−δ\tilde{L}z[k]+δu[k], (31)

z[k+1]=z[k]+δ\tilde{L}x[k]. (32)

After introducing the tuning parameter γ to (31) and (32), arrive at (12) and (13) noted above.

The systems, methods, devices, and logic described above may be implemented in many different ways in many different combinations of hardware, software or both hardware and software. For example, all or parts of the system may include circuitry in a controller, a microprocessor, or an application specified integrated circuit (ASIC), or may be implemented with discrete logic or components, or a combination of other types of analog or digital circuitry, combined on a single integrated circuit or distributed among multiple integrated circuits.

Many modifications and other embodiments set forth herein can come to mind to one skilled in the art having the benefit of the teachings presented in the foregoing descriptions and the associated drawings. Although specified terms are employed herein, they are used in a generic and descriptive sense only and not for purposes of limitation.

1. A system, comprising:
a first photovoltaic sub-module connected with a second photovoltaic sub-module;
a first differential power processing converter connected with the first photovoltaic submodule and the second photovoltaic sub-module;
a third photovoltaic sub-module connected with the second photovoltaic sub-module and the first differential power processing converter; and
a second differential power processing converter connected with the first differential power processing converter, the first photovoltaic sub-module, the second photovoltaic sub-module and the third photovoltaic sub-module, where the second differential power processing converter communicates with the first differential power processing converter to exchange an information about determined perturbation of the first differential power processing converter and the second differential power processing converter.

2. The system of claim 1, where the first differential power processing converter and the second differential power processing converter process the information to maximize a power from the first photovoltaic sub-module, the second photovoltaic sub-module and the third photovoltaic sub-module.

3. The system of claim 2, where the power is maximized for a constant string current.

4. The system of claim 3, where the first differential power processing converter performs a slow control loop and a fast control loop with an iteration interval faster than the slow control loop to step up or step down the string current.

5. The system of claim 1, where the voltage is maximized for a constant string current.

6. The system of claim 1, where the first differential power processing converter is positioned adjacent to the second differential power processing converter.

7. The system of claim 1, where the perturbation comprises a duty ratio of the first differential power processing converter and a duty ratio of the second differential power processing converter.

8. The system of claim 7, where the duty ratio corresponds to a maximum power point.

9. The system of claim 1, where the first differential power processing converter communicates wirelessly with the second differential power processing converter.

10. The system of claim 1, further comprising a level shifter to shift signals carrying the information.

11. A method, comprising:
providing a current to a string of photovoltaic modules, the photovoltaic modules including photovoltaic sub-modules;
determining a perturbation for the photovoltaic sub-modules; and
communicating information about the perturbation between a first differential power processing converter and a second differential power processing converter.

12. The method of claim 11, further comprising maximizing a power for the photovoltaic sub-modules based on the information.

13. The method of claim 12, where the power is maximized for a constant string current.

14. The method of claim 13, further comprising performing a slow control loop and a fast control loop with an iteration interval faster than the slow control loop to step up or step down the string current.

15. The method of claim 14, where the voltage is maximized for a constant string current.

16. The method of claim 11, further comprising positioning the first differential power processing converter adjacent to the second differential power processing converter.

17. The method of claim 11, where the perturbation comprises a duty ratio of the first differential power processing converter and a duty ratio of the second differential power processing converter.

18. The method of claim 17, where the duty ratio corresponds to a maximum power point.

19. The method of claim 11, further comprising communicating wirelessly between the first differential power processing converter and the second differential power processing converter.

20. The method of claim 11, further comprising shifting signals carrying the information.
